(19) United States
(12) Patent Application Publication
(10) Pub. No.: US 2007/0056004 A1
(43) Pub. Date: Mar. 8, 2007

(54) Upgrade module, packaging therefor and method of incorporating the same

(75) Inventors: John R. Rose, Swissvale, PA (US); Paul S. Romanko, Seward, PA (US)

Correspondence Address: ECKERT SEAMANS CHERIN & MELLOTT, 600 GRANT STREET, 44TH FLOOR, PITTSBURGH, PA, 15219, US

(73) Assignee: AMERICAN AUTO-MATRIX LLC, Export, PA (US)

(21) Appl. No.: 10/572,219

(22) PCT Filed: Sep. 23, 2004
(86) PCT No.: PCT/US04/31111

§ 371 Date: Mar. 16, 2006

Related U.S. Application Data
(60) Provisional application No. 60/505,070, filed on Sep. 23, 2003.

(51) Int. Cl. H04N 7/173

(52) U.S. Cl. 725/105

(57) ABSTRACT

Packaging (2) for an upgrade module (4, 104, 204a, 204b, 204c, 204d) includes a spacer (24) with an aperture (28) receiving a printed circuit board (PCB) (30) and a housing (26) enclosing the spacer (24) and PCB (30). In one embodiment, the housing is a labeled overlay (26) including an inner surface (36) engaging the spacer (24), an outer surface (38) with printed information (40) and a removable writeable portion (42). The overlay (26) includes openings (44, 46, 48) for access to, for example, the PCB (30), and first, second and third portions (50, 52, 56) which fold around and adhere to three sides of the spacer (24). The module (4, 104, 204a, 204b, 204c, 204d) is incorporated within or proximate to an analog sensor (14, 114) for conversion of the sensor (14, 114) into a digital communicating device. An optional fastening mechanism (70) secures the module (4, 104, 204a, 204b, 204c, 204d) in position. A method of assembling and employing the upgrade module (4, 104, 204a, 204b, 204c, 204d) in position. A method of assembling and employing the upgrade module (4, 104, 204a, 204b, 204c, 204d) and packaging therefor is also disclosed.

### CROSS-REFERENCE TO RELATED APPLICATION

This application is related to commonly assigned U.S. Provisional Patent Application Ser. No. 60/505,070, filed Sep. 23, 2003, entitled: “General Purpose Controller”.

### BACKGROUND OF THE INVENTION

1. Field of the Invention

The present invention relates to analog sensors and, more particularly, to an upgrade module designed to convert at least one signal received from an analog sensor into a digital value and communicate such value to a digital communications network. The invention also relates to packaging for upgrade modules and to a method of upgrading analog sensors.

2. Background Information

It is often desirable to convert analog signals obtained from an analog sensor into a digital value which can be readily interpreted by an end user. For example, in the Heating Ventilating and Air Conditioning (HVAC) industry, temperature readings are often obtained as analog signals (e.g., without limitation, as a resistance value; a voltage; a current) through, for example, use of an analog sensor, such as a thermistor. It is often appealing to receive these analog signals as input and convert them into a digital output, such as a digital temperature value in degrees Fahrenheit, which can be displayed, for example, on the user interface of a digital thermostat. Analog to digital converters, which perform such functions, are well known.

However, as digital output features (e.g., without limitation, displays; LCD; LED; audio; graphical interfaces) become increasingly complex, there is a strong demand for improved, smaller size, multi-function controllers for providing the analog to digital conversions and communicating the converted information to one or more digital devices. It is, therefore, highly desirable to be able to provide a single upgrade module which may be incorporated with an analog sensor to convert the analog sensor into a digital communicating device. It is also desirable to provide packaging for such a module which permits it to be small, economical to produce and aesthetically pleasing.

Hence, there is room for improvement in upgrade modules, in packaging for upgrade modules and in methods of upgrading analog sensors using upgrade modules.

### SUMMARY OF THE INVENTION

These needs and others are met by the present invention, which provides an upgrade module and packaging therefor which is economical to produce, and small in size such that it may be readily incorporated within or proximate to an analog sensor in order to convert it into a digital communicating device. Specifically, the exemplary upgrade module and packaging may be small enough to easily fit within a standard two inch by four inch utility box without interrupting preexisting internal structures (e.g., analog sensor; electrical circuitry). The upgrade module and packing therefor may present flexible input and output and programmability options thus, providing the ability to convert almost any end-point device into a digitally communicating device using a low cost, add-on circuit.

As one aspect of the invention, packaging is for an upgrade module including a converter and a digital communication interface for converting at least one analog signal received from an analog sensor to at least one digital value and communicating the at least one digital value to a digital communication network. The packaging comprises: housing structured to enclose electrical components including the converter and the digital communication interface, and to incorporate the electrical components within or proximate to the analog sensor.

The housing may be an overlay or the combination of an overlay and a spacer wherein the spacer includes an aperture structured to receive the electrical components and the overlay is structured to overlay the spacer and the electrical components in order to secure the electrical components therein. The overlay may include printed information and a number of openings structured to provide access to one or more of the electrical components housed therein. The spacer may be made from a UL-approved material such as R31 foam. The electrical components may include a printed circuit board, wherein the printed circuit board is received and secured within the aperture of the spacer.

The overlay may be a foldable label made from UL-approved material, such as polyester, and comprising: an inner surface structured to engage the spacer; an outer surface including the printed information; a removable writeable portion; and the aforementioned number of openings for receiving portions of the electrical components therethrough. The foldable label may be folded to include first, second and third portions which, when folded, respectively engage the spacer on three sides, thereby enclosing the electrical components therein. The foldable label may include an adhesive on the inner surface in order to adhere to the spacer. The packaging may include a fastener mechanism for securing the upgrade module within or proximate to the analog sensor.

As another aspect of the invention, an upgrade module is for upgrading an analog sensor having at least one analog signal. The upgrade module comprises: a converter for converting the at least one analog signal to at least one digital value; a digital communication interface communicating the at least one digital value to a digital communication network; and packaging comprising: a housing for enclosing and incorporating the converter and the digital communication interface within or proximate to the analog sensor.

The housing may be an overlay or the combination of an overlay and a spacer wherein the spacer includes an aperture for receiving electrical components including the converter and the digital communication interface therein, and the overlay overlies and secures the spacer and the electrical components. The overlay may include printed information and a number of openings which provide access to one or more of the electrical components housed therein.

The upgrade module may be adapted to be incorporated within a utility box proximate the analog sensor.

As another aspect of the invention, a method is for upgrading an analog sensor to communicate over a digital communication network. The analog sensor has at least one analog signal. The method comprises: employing a converter to convert the at least one analog signal to at least one digital value; employing a digital communication interface to communicate the at least one digital value to the digital communications network; and providing packaging including a housing for enclosing electrical components including the converter and the digital communication interface and incorporating such electrical components within or proximate to the analog sensor in order to form an upgrade module.

The method may include providing as the housing, an overlay or the combination of an overlay and a spacer wherein the spacer includes an aperture for receiving electrical components including the converter and the digital communication interface therein, and the overlay overlies and secures the spacer and the electrical components. The overlay may include printed information and a number of openings which provide access to one or more of the electrical components housed therein.

The method may include: providing as the spacer, a spacer made from a UL-approved material; providing as the electrical components a printed circuit board; and receiving and securing the printed circuit board within the aperture of the spacer. The method may further include: providing as the labeled overlay a printed label made from UL-approved material and including an inner surface engaging the spacer, an outer surface including the printed information, a removable writeable portion and the number of openings for receiving portions of the electrical components therethrough; providing the printed label with first, second and third foldable portions; folding the first, second and third foldable portions in order to respectively engage the spacer on three sides thereby enclosing the electrical components therein; and employing an adhesive on the inner surface of the printed label in order to adhere to the spacer.

The packaging may be provided with a fastener mechanism selected from the group consisting of adhesive tape, glue and fastener, in order to secure the upgrade module within or proximate to the analog sensor. For example, the method may include the step of incorporating the upgrade module within a utility box proximate the analog sensor.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of an analog sensor and upgrade module therefor with the module housing being proximate the analog sensor in accordance with the present invention.

FIG. 2 is a schematic diagram of an analog sensor and upgrade module therefor wherein the module housing is within the analog sensor in accordance with another embodiment of the invention.

FIG. 3 is a plan view of the outer surface of a labeled overlay for the packaging of the upgrade module in accordance with another embodiment of the present invention.

FIG. 4 is a plan view of the inner surface of the labeled overlay of FIG. 3 and a spacer structured to fit therebetween.

FIG. 5 is a plan view of the packaging assembly of FIG. 4 further including a printed circuit board disposed within the aperture of the spacer.

FIG. 6 is a plan view of the opposite side of the assembly of FIG. 5, showing electrical components protruding from openings in the labeled overlay.

FIG. 7 is a plan view of the packaging assembly of FIG. 6 after being folded and secured, in order to form the upgrade module.

FIG. 8 is a plan view of the opposite side of the packaging assembly of FIG. 7 showing printed information on the removable writeable portion of the labeled overlay.

FIG. 9 is an isometric view of the upgrade module of FIG. 8 as incorporated proximate a utility box and analog sensor in accordance with another embodiment of the invention.

FIG. 10 is an isometric view of the upgrade module of FIG. 8 as incorporated within the utility box of FIG. 9 in accordance with another embodiment of the invention.

FIG. 11 is a schematic diagram of a master controller for connection with a plurality of analog sensors and upgrade modules therefor.

### DESCRIPTION OF THE PREFERRED EMBODIMENTS

For purposes of illustration, the invention will be described and illustrated as applied to an upgrade module and packaging therefor which are incorporated within or proximate to an analog sensor that is within or proximate to a utility box, although it will become apparent that it could also be applied to any type of analog sensor (e.g., without limitation, thermistors; thermometers; a sensor having a voltage output; a sensor having a current output) with or without an enclosure and within or proximate to such enclosure.

As employed herein, the term “number” refers to one or more than one (i.e., a plurality).

As employed herein, the terms “fastener” and “fastening mechanism” refer to any suitable connecting or attachment mechanism expressly including, but not limited to, screws, bolts, combinations of bolts and nuts, adhesive tapes (e.g., double-sided tape), glues and other suitable fasteners.

As employed herein, the term “aperture” explicitly includes, but is not limited to, holes or slots which extend partially or completely through a component as well as a recess, for example, in the component which is structured to receive at least a portion of a second component or part.

As employed herein, the phrases “approved material” and “approved process” refer to a material or process (e.g., the printing process employed on the exemplary removable writable portion), which is expressly recognized as approved by an approval agency or an approval program such as the Underwriter's Laboratory (UL), which establishes well known industry safety standards. For example, the exemplary processes and materials of the upgrade module and packaging therefor of the present invention are UL-listed and, therefore, are officially approved by the Underwriter's Laboratory and recognized within the industry as having a superior safety rating. However, it will be appreciated that approval of materials and processes can vary considering and, therefore, the present invention contemplates use of any known or suitable materials and processes in addition to those that are UL-listed and/or UL-approved.

As employed herein, “printed information” refers to information which has been printed, using, for example, UL-approved processes and UL-approved materials, on the exemplary labeled overlay of the present invention. Such information expressly includes, but is not limited to, upgrade module information, instructions, warnings, identification labels and markings, electrical ratings and parameters, wiring schematics and safety information. Printed information also includes additional printed information which may be subsequently printed on or applied to the exemplary removable writable portion of the labeled overlay using, for example, an indelible pen.

As employed herein, the statement that two or more parts are “coupled” together shall mean that the parts are joined together either directly or joined through one or more intermediate parts.

As employed herein, directional phrases such as up, down, top, bottom, side and derivatives thereof refer to the invention as illustrated in the figures and are not limiting upon the invention.

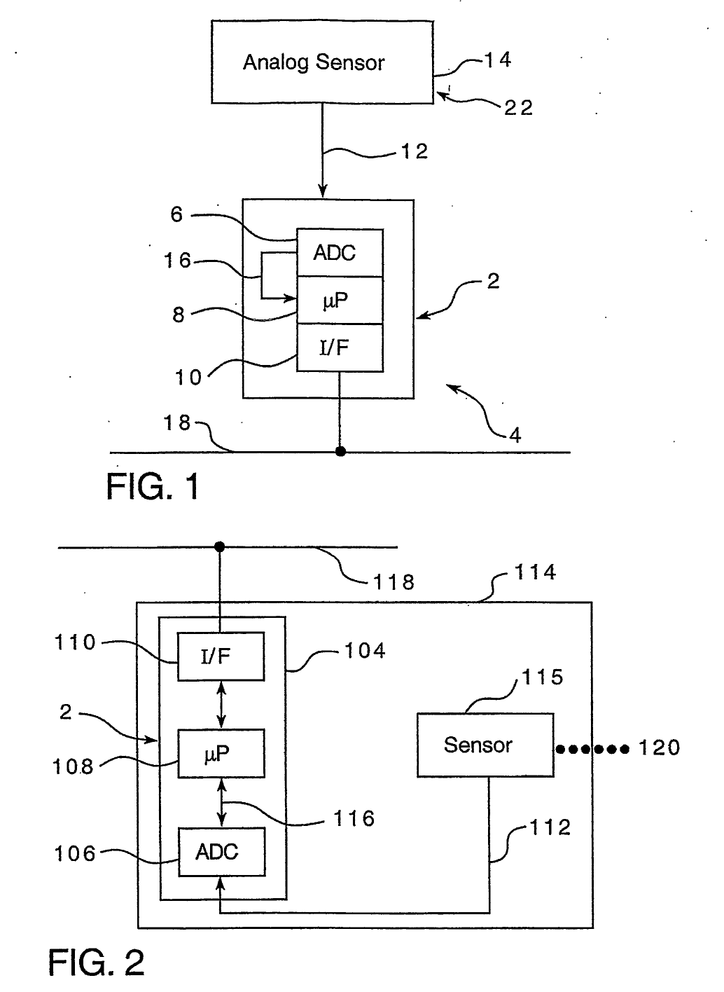

FIG. 1 shows a housing or packaging 2 of an upgrade module 4 for an analog sensor 14 with the module housing or packaging 2 being proximate the analog sensor 14. The packaging 2, as will be described in further detail herein, provides an insulating enclosure for the upgrade module 4. The upgrade module 4 includes an analog to digital converter (ADC) 6, a suitable processor (PP) 8 and a digital communication interface (I/F) 10. In operation, the analog to digital converter 6 receives an analog signal 12 from the analog sensor 14 and converts it into a digital value 16 which is processed by the processor 8 and communicated by the digital communication interface 10 to a digital communication network 18. By way of practical example, without limitation, the analog sensor 14 could be a thermometer (not shown). The thermometer takes a temperature measurement and provides the analog signal 12 which, through use of the exemplary upgrade module 4, can be converted to the digital value 16, such as a digital temperature reading in degrees Fahrenheit (not shown), which is then communicated by the digital communication interface 10 to the digital communication network 18 for display, for example, on a digital user interface (not shown), such as on the front of a thermostat (not shown) for the heating, ventilating and air conditioning (HVAC) system (not shown) of a home or commercial building.

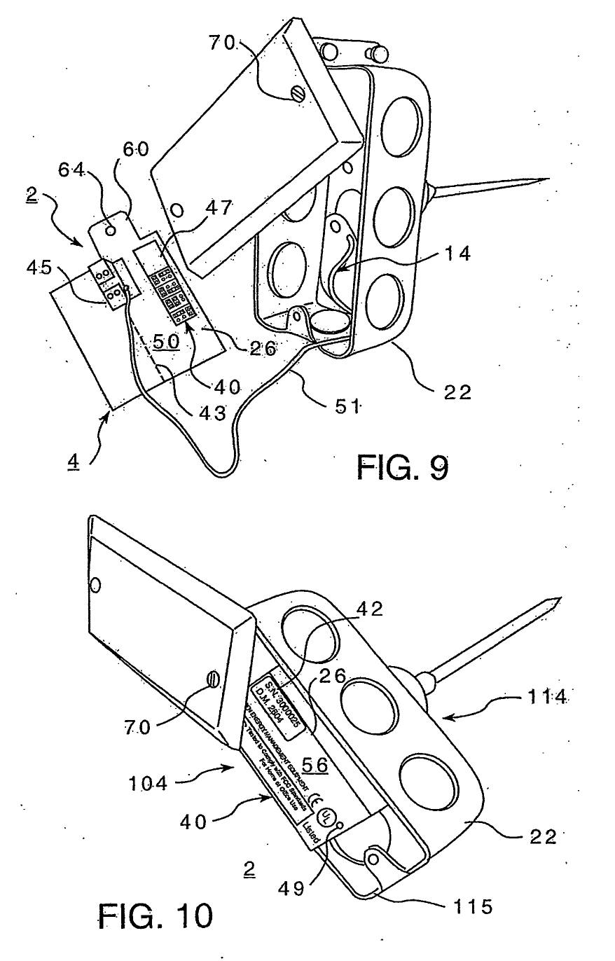

FIG. 2 shows an analog sensor 114 including a sensor portion 115 and upgrade module 104 therefor with the housing or packaging 2 being disposed within the analog sensor 114 rather than proximate thereto, as in FIG. 1, previously discussed. By way of a representative example, which is not intended to be limiting upon the present invention, FIG. 10 shows the exemplary upgrade module 104 within a two inch by four inch utility box 22 and sensor portion 115, whereas FIG. 9 shows a representative example of the embodiment of FIG. 1, wherein the upgrade module 4 is incorporated proximate the utility box 22 and analog sensor 14. As shown in FIG. 2, the upgrade module 104, like the upgrade module 4 of FIG. 1, includes an analog to digital converter (ADC) 106, a suitable processor (μP) 108 and a digital communication interface (I/F) 110. In operation, a sensed parameter 120 (e.g., without limitation, a temperature; a pressure; a voltage; a current) is obtained by the sensor portion 115 which provides the analog signal 112. Then, as previously discussed, analog to digital converter 106 of the upgrade module 104 converts the analog signal 112 into the digital value 116 which is processed by the processor 108 and communicated by the digital communication interface 110 to the digital communication network 118.

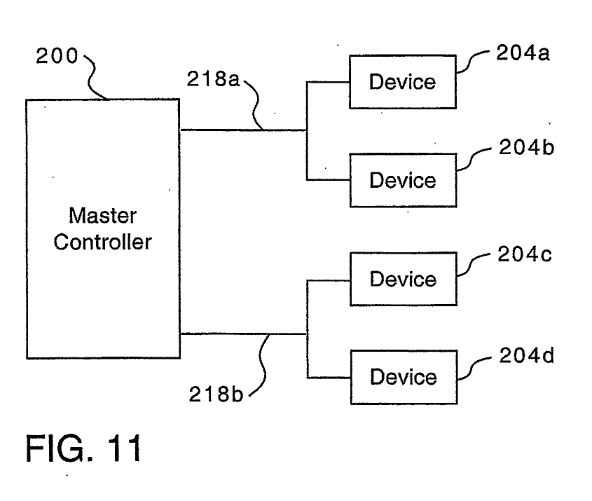

It will be appreciated that the schematic embodiments illustrated in FIGS. 1 and 2 are merely provided to help further clarify the present invention by showing two possible alternative configurations of the upgrade modules 4, 104 as it may be incorporated within (FIG. 2) or proximate to (FIG. 1) the respective analog sensors 14, 114. Any known or suitable alternative configuration could be employed. For example, as will be discussed in further detail herein with respect to FIG. 11, a plurality of devices could be connected to a master controller 200, with each device having its own upgrade module 204a, 204b, 204c, 204d for converting analog signals to digital values for communication on one or more digital communication networks 218a, 218b.

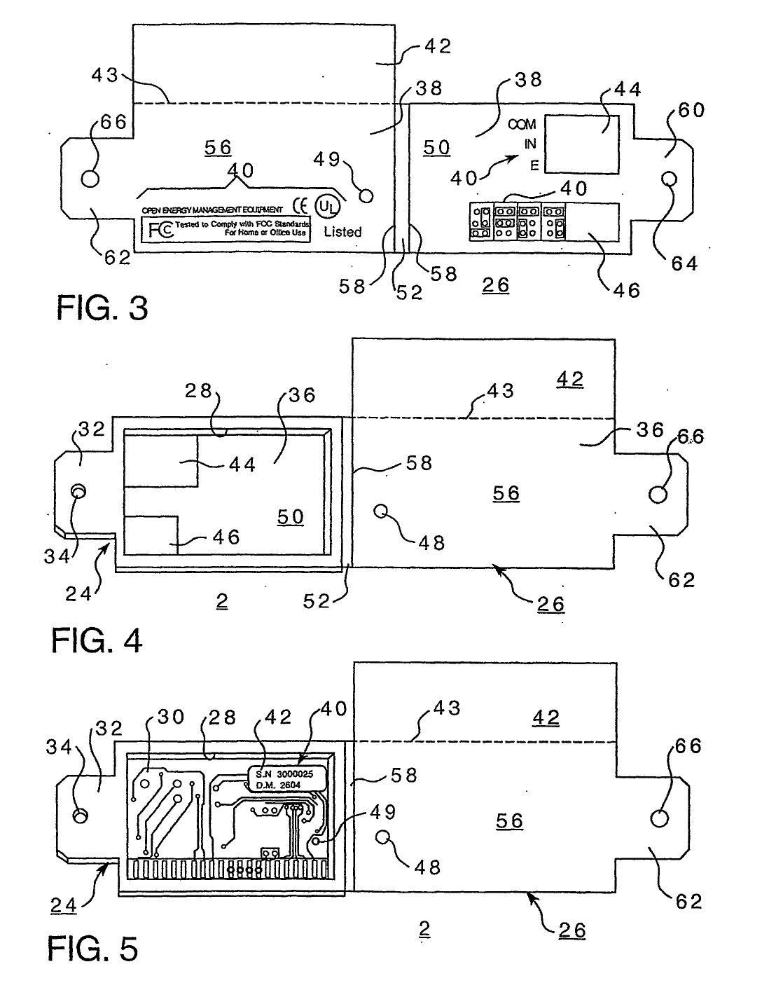

FIGS. 3-8 illustrate the components of the exemplary packaging 2 for the upgrade modules 4, 104, 204a, 204b, 204c, 204d wherein the housing or packaging 2 includes a spacer 24 and labeled overlay 26 assembly (best shown in FIG. 4). When viewed sequentially, FIGS. 3-7 illustrate the steps of assembling the exemplary upgrade module 4.

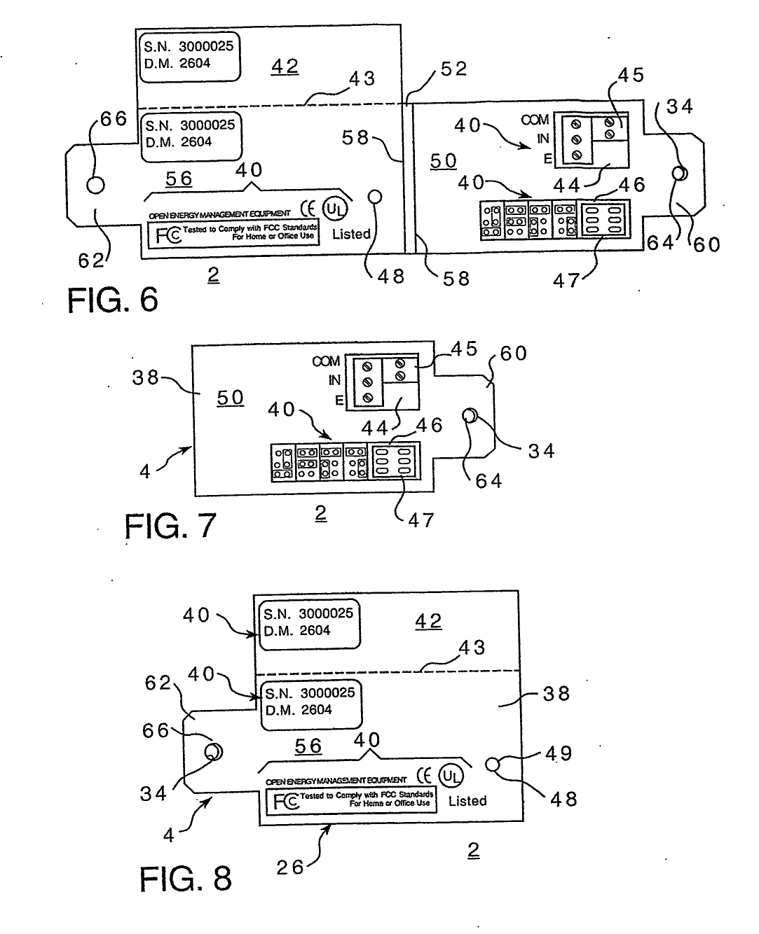

FIG. 3 shows the outer surface 38 of the labeled overlay 26. As previously discussed, the exemplary labeled overlay 26 is preferably composed of a UL-listed material and includes printed information 40 which is applied using a suitable UL-approved printing process. Specifically, the labeled overlay 26 is preferably made from a polyester with a clear laminate overlying the outer surface 38 and an adhesive backing on the inner surface 36 (FIG. 4), which facilitates attachment to the spacer 24 (FIG. 4). The printed information 40 may include, for example, upgrade module information, instructions, warnings, identification labels and markings, electrical ratings and parameters, wiring schematics and safety information. The exemplary labeled overlay 26 includes suitable rating information (see e.g., UL-listed and FCC testing printed information of FIG. 3). It also includes electrical component labels and wiring schematics (best shown in FIGS. 6 and 7).

Continuing to refer to FIGS. 3-8, the labeled overlay 26 includes the inner surface 36 structured to engage the spacer 24. The spacer 24 includes an aperture 28 structured to receive electrical components such as the analog to digital converter 6 (FIG. 1), the processor 8 (FIG. 1) and the digital communication interface 10 (FIG. 1). As shown in FIG. 5, the exemplary electrical components are included upon a printed circuit board (PCB) 30, which fits securely within the aperture 28 of spacer 24.

The exemplary spacer 24 is generally rectangular in shape and includes a tab 32 with a hole 34 corresponding to first and third foldable portions 50, 56 and tabs 60, 62 and holes 64, 66 thereof of the labeled overlay 26. The exemplary spacer 24 is made from UL-listed R31 foam which is about ⅛ inch thick. Accordingly, the foam spacer 24 provides a protective, insulating housing for the exemplary circuit board 30 (best shown in FIG. 5). However, it will be appreciated that any known or suitable material other than the exemplary R31 foam could be employed. It will also be appreciated that the spacer 24 could be of any suitable dimension and configuration in order to house electrical components (e.g., 30), in a desired configuration, therein.

The labeled overlay is preferably a printed label 26 which is foldable to include first, second and third portions 50, 52, 56, which, when folded, respectively engage the spacer 24 on three sides, in order to enclose the PCB 30 therein. Specifically, the first foldable portion 50 is generally rectangular in shape and includes the tab 60 and opening 64 which correspond to tab 32 and opening 34 of spacer 24. The first portion 50 further includes a number of openings, such as the exemplary first and second openings 44, 46 which receive or provide access to electrical components housed within the packaging 2. In the examples of FIGS. 6 and 7, opening 44 receives a pluggable terminal block 45 therethrough and opening 46 provides access to mini jumpers 47. The mini jumpers 47 may be configured in a variety of electrical orientations as shown on the wiring diagram printed information 40 adjacent opening 46 in FIGS. 6 and 7. For example, the exemplary mini jumpers 47 or other suitable electrical components (not shown) can be configured as desired for the particular desired electrical application in order to provide, for example, input of a voltage, a current or a resistance. Similarly, the electrical components (e.g., pluggable terminal block 45) received through opening 44 may be labeled with printed information 40, such as the communication network, input and power terminals labeling shown in FIGS. 6 and 7. The third foldable portion 56 of the exemplary labeled overlay 26 includes a hole 48 for a light emitting diode (LED) 49, which provides a visual indication of the operating condition of the upgrade module 4.

It will, however, be appreciated that the housing (e.g., without limitation, labeled overlay 26) may include any number of openings (e.g., 44, 46, 48) in any number of configurations, in order to provide access to the interior of packaging 2.

The second foldable portion 52 of the labeled overlay 26 is disposed between the first and third foldable portions 50, 56 and includes scorelines or bends 58 at either edge thereof, in order to permit the overlay 26 to be folded around spacer 24 (best shown in FIG. 5). As previously discussed, the steps of the exemplary method of assembly of the upgrade module 4 is shown sequentially in FIGS. 4-7.

Specifically, the inner surface 36 of the overlay 26 includes an adhesive. The exemplary adhesive is a flexible double-sided tape (not shown). Assembly of the exemplary upgrade module 4 begins by removing the backing (not shown) of such tape to expose the adhesive surface 36. The spacer 24 is then aligned with first foldable portion 50 and secured thereto (FIG. 4). As shown in FIG. 5, the exemplary circuit board 30 is then inserted into the aperture 28 of the spacer 24 such that the exemplary pluggable terminal block 45 (FIG. 6) and the mini jumpers 47 (FIG. 6) align with openings 44, 46, respectively. The labeled overlay 26 is then folded along bends 58 of second foldable portion 52 such that the second foldable portion 52 engages the perpendicular edge of spacer 24 and continues to be folded around the spacer 24 until the inner surface 36 of third foldable portion 56 adheres to the opposite side of spacer 24. Accordingly, the foam spacer 24 and printed overlay 26 of the present invention provide an economical, protective and insulating housing or package 2 for the upgrade modules 4, 104, 204a, 204b, 204c, 204d, which is small in size. FIG. 7 shows a first side of the assembled upgrade module 4 with the outer surface 38 of first foldable portion 50 being shown. FIG. 8 shows the opposite side of the assembled upgrade module 4. As shown, when assembled, the tabs 60, 62 and holes 64, 66 of the first and third foldable portions 50, 56, align with tab 32 (FIG. 4) and hole 34 of spacer 24 therebetween.

Referring to FIG. 8, the exemplary labeled overlay 26 (FIG. 3) includes a removable writeable portion 42. The exemplary removable writeable portion 42 is integral with the third portion 56 of the overlay 26 and severable therefrom by way of a plurality of perforations 43. As previously discussed, the removable writeable portion 42 may include printed information 40 such as, for example, an identification label, which may be removed and attached at a location readily viewable on the module 4 or remote therefrom, for convenience of the end user. For example, the removable writeable portion 42 or a portion thereof may be removed and secured to the exemplary PCB 30, as shown in FIG. 5. Alternatively, as shown in FIG. 10, such portion may be removed and applied to the exterior of the packaging 2 at a location which may be readily viewed and identified. Alternatively, the removable writeable portion 42 may be severed and disposed at a location entirely remote from the sensor 14, 114 (FIGS. 9 and 10), for example, in a file for recordkeeping purposes. The printed information 40 disposed upon the removable writeable portion 42, like printed information 40 on the labeled overlay 24, is preferably comprised of UL-listed materials and printed using UL-approved processes. As shown in FIG. 8, a duplicate of the printed information 40, such as the serial number and date of manufacture, shown, may be included both on the removable writeable portion 42 and on another portion of the labeled overlay 26. It will also be appreciated that printed information 40 may be subsequently applied to the removable writeable portion 42 by the end user, for example, through use of an indelible pen.

The sequential combination of the foregoing FIGS. 3-8 shows the sequential steps of a process of assembling one of the upgrade modules 4,104.

FIGS. 9 and 10 show upgrade modules 4, 104, respectively, which have been assembled in accordance with the aforementioned embodiment of the present invention, as shown in FIGS. 3-8. The modules 4 and 104 are shown as employed with a two inch by four inch utility box 22 and analog sensor 14 and 114. FIG. 9 shows the upgrade module as employed proximate to the utility box 22 (corresponding, for example, to FIG. 1), while FIG. 10 shows the upgrade module 104 incorporated within the utility box 22 (corresponding, for example, to FIG. 2). In either configuration, the upgrade modules 4 and 104 and packaging 2 therefor provide a small, efficient mechanism for upgrading the analog sensor 14 and 114 as previously discussed. Specifically, as best shown in FIG. 9, the module 4 may be quickly connected by one or more wires 51 to the analog sensor 14. The small size of the modules 4, 104 permit them to be located in any suitable location proximate to (FIG. 9) or within (FIG. 10) the analog sensors 14, 114. An optional fastening mechanism such as the exemplary screw fastener 70 may be included to facilitate securing the modules 4, 104. The exemplary screw 70 may be inserted through the aligned holes 64, 66, 34 in tabs 60, 62, 32 of the overlay first and third portions 50, 56 and spacer therebetween 24, in order to be aligned with an existing hole of the utility box 22 (FIG. 10). It will, however, be appreciated that any alternative known or suitable fastening mechanism (not shown) such as adhesive tape, glue or other suitable fastener may be employed to secure the modules 4, 104 proximate to (FIG. 9) or within (FIG. 10) the analog sensors 14, 114. Alternatively, no fastening mechanism 70 needs to be employed. It will also be appreciated that the utility box 22 illustrated in FIGS. 9 and 10 is but one possible application for the exemplary upgrade modules 4, 104 and packaging 2 therefor, of the present invention.

As shown in the schematic diagram of FIG. 11, it will also be appreciated that a plurality of devices each employing upgrade modules 204a, 204b, 204c, 204d, in accordance with the present invention, may be employed in connection with one or more digital communication networks 218a, 218b, which are connected to and controlled by a master controller 200. The particular features and functional details of the master controller (e.g., 200) are a function of the intended application. In general, the master controller 200 may provide power and network control and manage the plurality of devices (e.g., 204a, 204b, 204c, 204d) attached to the one or more digital communication networks (e.g., 218a, 218b).

It will also be appreciated that although the packaging 2 has been described and illustrated herein as comprising a foam spacer 24 and polyester labeled overlay 26, that alternative packaging enclosures (not shown) are also within the scope of the present invention. For example, the upgrade module housing could alternatively comprise a molded shell, such as a plastic clam shell housing (not shown) that surrounds the electrical components. Additionally, the housing or packaging could alternatively comprise a conformal coating (e.g., without limitation, by dipping the PCB 30 in a hardenable insulating material) (not shown).

It will also be appreciated that although the invention has been shown and described herein as a packaged module for a sensor (e.g., 14), it is also possible for the sensor to be made to include the ADC and digital interface as a pre-packaged assembly (not shown) which is ready to function as a digital sensor for use with a user-supplied controller.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. Packaging (2) for an upgrade module (4,104,204a,204b,204c,204d) including a converter (6,106) and a digital communication interface (10,110) for converting at least one analog signal (12,112) received from an analog sensor (14,114) to at least one digital value (16,116) and communicating said at least one digital value (16,116) to a digital communication network (18,118,218a,218b), said packaging (2) comprising:
a housing (26) structured to enclose electrical components comprising said converter (6,106) and said digital communication interface (10,110) and to incorporate said electrical components (6,10; 106,110) within or proximate to said analog sensor (14,114).

2. The packaging (2) of claim 1 wherein said housing is an overlay (26) structured to overlay said electrical components (6,10; 106,110).

3. The packaging (2) of claim 1 wherein said housing is an overlay (26) and a spacer (24); wherein said spacer (24) includes an aperture (28) structured to receive said electrical components (6,10; 106,110) therein; and wherein said overlay (26) is structured to overlay said spacer (24) and said electrical components (6,10; 106,110) in order to secure said electrical components (6,10; 106,110) therein.

4. The packaging (2) of claim 3 wherein said overlay is a foldable label (26) including printed information (40) and a number of openings (44,46) structured to provide access to one or more of said electrical components (6,10; 106,110) housed therein.

5. The packaging (2) of claim 3 wherein said electrical components further comprise a printed circuit board (30); and wherein said printed circuit board (30) is received and secured within said aperture (28) of said spacer (24).

6. The packaging (2) of claim 4 wherein said foldable label (26) comprises:
an inner surface (36) structured to engage said spacer (24);
an outer surface (38) including said printed information (40);
a removable writeable portion (42); and
said number of openings (44,46) for receiving portions of said electrical components (30) therethrough.

7. The packaging (2) of claim 6 wherein said spacer (24) is made from R31 foam; and wherein said foldable label (26) is made from polyester.

8. The packaging (2) of claim 6 wherein said foldable label (26) folds to include first, second and third portions (50,52,56) which, when folded, respectively engage said spacer (24) on three sides, thereby enclosing said electrical components (30) therein; and wherein said foldable label (26) includes an adhesive on said inner surface (36) in order to adhere to said spacer (24).

9. The packaging (2) of claim 1 wherein said housing (26) includes a fastening mechanism (70) for securing said upgrade module (4) within or proximate to said analog sensor (14,114).

10. The packaging (2) of claim 9 wherein said fastening mechanism (70) is selected from the group consisting of adhesive tape, glue and a fastener.

11. An upgrade module (4,104,204a,204b,204c,204d) for upgrading an analog sensor (14,114) having at least one analog signal (12,112), said upgrade module (4,104,204a,204b,204c,204d) comprising:
a converter (6,106) for converting said at least one analog signal (12,112) to at least one digital value (16,116);
a digital communication interface (10,110) communicating said at least one digital value (16,116) to a digital communication network (18,118,218a,218b); and
a housing (26) for enclosing electrical components including said converter (6,106) and said digital communication interface (10,110) and incorporating said electrical components (6,10; 106,110) within or proximate to said analog sensor (14,114).

12. The upgrade module (4,104,204a,204b,204c,204d) of claim 11 wherein said housing is an overlay (26) overlying said electrical components (6,10; 106,110).

13. The upgrade module (4,104,204a,204b,204c,204d) of claim 11 wherein said housing is an overlay (26) and a spacer (24); wherein said spacer (24) includes an aperture (28) receiving said electrical components (6,10; 106,110) therein; and wherein said overlay (26) overlies said spacer (24) and said electrical components (6,10; 106,110) in order to secure said electrical components (6,10; 106,110) therein.

14. The upgrade module (4,104,204a,204b,204c,204d) of claim 13 wherein said overlay is a foldable label (26) comprising:
an inner surface (36) engaging said spacer (24);
an outer surface (38) including printed information (40);
a removable writeable portion (42); and
a number of openings (44,46) structured to provide access to one or more of said electrical components (6,10; 106,110) housed within said packaging (2).

15. The upgrade module (4,104,204a,204b,204c,204d) of claim 13 wherein said electrical components include a printed circuit board (30); and wherein said printed circuit board (30) is received and secured within said aperture (28) of said spacer (24).

16. The upgrade module (4,104,204a,204b,204c,204d) of claim 15 wherein said spacer (24) is made from R31 foam; and wherein said foldable label (26) is made from polyester.

17. The upgrade module (4,104,204a,204b,204c,204d) of claim 14 wherein said foldable label (26) folds to include first, second and third portions (50,52,56) which, when folded, respectively engage said spacer (26) on three sides, thereby enclosing said electrical components (6,10; 106,110; 30) therein; and wherein said foldable label (26) includes an adhesive on said inner surface (36) in order to adhere to said spacer (26).

18. The upgrade module (4,104,204a,204b,204c,204d) of claim 11 wherein said housing (26) includes a fastening mechanism (70) selected from the group consisting of adhesive tape, glue and fastener, in order to secure said upgrade module (4,104,204a,204b,204c,204d) within or proximate to said analog sensor (14,114).

19. The upgrade module (4,104,204a,204b,204c,204d) of claim 18 adapted to be incorporated within a utility box (22) proximate said analog sensor (14).

20. A method for upgrading an analog sensor (14,114) to communicate over a digital communication network (18,118,218a,218b), said analog sensor (14,114) having at least one analog signal (12,112), said method comprising:
employing a converter (6,106) to convert said at least one analog signal (12,112) to at least one digital value (16,116);
employing a digital communication interface (10,110) to communicate said at least one digital value (16,116) to said digital communications network (18,118,218a,218b); and
providing a housing (26) for enclosing electrical components including said converter (6,106) and said digital communication interface (10,110) and incorporating said electrical components (6,10; 106,110) within or proximate to said analog sensor (14,114), in order to form an upgrade module (4,104,204a,204b,204c,204d).

21. The method of claim 20 including providing as said housing an overlay (26) overlying said electrical components (6,10; 106,110).

22. The method of claim 20 including providing as said housing an overlay (26) and a spacer (24); wherein said spacer (24) includes an aperture (28) receiving said electrical components (6,10; 106,110) therein; and wherein said overlay (26) overlies said spacer (24) and said electrical components (6,10; 106,110) in order to secure said electrical components 6,10; 106,110) therein.

23. The method of claim 22 further including:
providing as said electrical components a printed circuit board (30); and
receiving and securing said printed circuit board (30) within said aperture (28) of said spacer (24).

24. The method of claim 23 further including:
providing as said overlay a foldable label (26) including an inner surface (36) engaging said spacer (26), an outer surface (38) including printed information (40), a removable writeable portion (42) and a number of openings (44,46) for receiving portions of said electrical components (30) therethrough;
providing said foldable label (26) with first, second and third foldable portions (50,52,56);
folding said first, second and third foldable portions (50,52,56) in order to respectively engage said spacer (24) on three sides, thereby enclosing said electrical components (30) therein; and
employing an adhesive on said inner surface (36) of said foldable label (26) in order to adhere to said spacer (24).

25. The method of claim 20 including providing a fastening mechanism (70) selected from the group consisting of adhesive tape, glue and fastener, in order to secure said upgrade module (4,104,204a,204b,204c,204d) within or proximate to said analog sensor (14,114).

26. The method of claim 25 including incorporating said upgrade module (4) within a utility box (22) proximate said analog sensor (14).
